(19) United States
(12) Patent Application Publication
(10) Pub. No.: US 2016/0272230 A1
(43) Pub. Date: Sep. 22, 2016

(54) SYSTEM AND METHOD FOR TRANSPORTING GLASS AND GLASS PRODUCTS

(71) Applicant: Oldcastle BuildingEnvelope, Inc., Dallas, TX (US)

(72) Inventors: Edwin Hathaway, Santa Monica, CA (US); Mary Carol Witry, Dallas, TX (US); Todd Leslie, Wills Point, TX (US); Jason Ferraro, Heartland, TX (US); Doug Watts, Terrell, TX (US); Steven Sherman, Valrico, FL (US)

(21) Appl. No.: 14/843,716

(22) Filed: Sep. 2, 2015

Related U.S. Application Data
(60) Provisional application No. 62/136,249, filed on Mar. 20, 2015.

(51) Int. Cl. B62B 3/10; B62B 5/06; B62B 3/02

(52) U.S. Cl. CPC B62B 3/108; B62B 3/02; B62B 5/06

(57) ABSTRACT

A wheeled container that includes a front face and a rear face disposed opposite the front face. A bottom surface is coupled to the rear face and the front face. A recessed skate housing is disposed in the bottom surface, the recessed skate housing comprises a slot that receives a caster assembly. The caster assembly is moveable within the slot between a first retracted position and a second deployed position.

### CROSS-REFERENCE TO RELATED APPLICATIONS

This application claims priority to, and incorporates by reference for any purpose the entire disclosure of, U.S. Provisional Patent Application No. 62/136,249, filed on Mar. 20, 2015.

### BACKGROUND

1. Technical Field

The present invention relates generally to systems and methods for transporting glass and glass products, and more particularly, but not by way of limitation to systems and methods for utilizing wheeled crates for transporting glass products over a variety of terrains.

2. Background

Crates and other packaging arrangements are well known and widely available for many different functions. Particularly, many crates are designed to prevent damage to fragile articles during transportation. For example, U.S. Pat. No. 4,182,450, which is incorporated herein by reference, discloses a crate for packaging multiple large fragile objects, such as windshields.

Shipping containers for transporting fragile objects having wheels attached thereto are also well known. For example, U.S. Pat. No. 6,742,663, which is incorporated herein by reference, discloses a shipping container with castered wheels for securely supporting panels, such as glass. In U.S. Pat. No. 7,540,381, which is incorporated herein by reference, a reusable shipping container for fragile objects is disclosed in which the container can optionally be fitted with wheels or casters in order to enable easy movement of the container onto and off of a vehicle. In U.S. Pat. No. 8,322,733, which is incorporated herein by reference, a wheeled, partitionable shipping crate for transporting relatively flat articles (e.g., TV, paintings, mirrors) is disclosed.

U.S. Pat. No. 7,530,580, which is incorporated herein by reference, discloses a transport assembly having a pallet-like carrying structure provided with wheels at each of the four corners. The transport assembly further comprises a plurality of containers designed to be stacked on top of the pallet-like carrying structure. In U.S. Pat. No. 6,983,946, which is incorporated herein by reference, a transportable container is disclosed having a wheeled support dolly capable of being attached to the transportable containers.

### SUMMARY OF THE INVENTION

The present invention relates generally to systems and methods for transporting glass and glass products, and more particularly, but not by way of limitation to systems and methods for utilizing wheeled crates for transporting glass products over a variety of terrains. In one aspect, the present invention relates to a wheeled container that includes a front face and a rear face disposed opposite the front face. A bottom surface is coupled to the rear face and the front face. A recessed skate housing is disposed in the bottom surface, the recessed skate housing comprises a slot that receives a caster assembly. The caster assembly is moveable within the slot between a first retracted position and a second deployed position.

In another aspect, the present invention relates to a method of transporting structural glass that includes moving a wheeled container that contains an article of structural glass. The wheeled container includes a front face, a rear face, and a bottom surface. A plurality of recessed skate housings are formed in the bottom surface. The method further includes retracting a caster coupled to the recessed skate housing such that the bottom surface is in contact with the ground and deploying a support flap from the rear face to a position generally perpendicular to the rear face. The wheeled container is supported with the support flap.

The above summary of the invention is not intended to represent each embodiment or every aspect of the present invention. Particular embodiments may include one, some, or none of the listed advantages.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a top plan view of a wheeled container in accordance with an exemplary embodiment;

FIG. 2 is a perspective view of a wheeled container in an open configuration according to an exemplary embodiment;

FIG. 3 is a perspective view of a wheeled container in a closed configuration according to an exemplary embodiment;

FIG. 4 is a perspective view of a wheeled container with a front panel removed according to an exemplary embodiment;

FIG. 5A is a rear plan view of a wheeled container showing stands formed therein in a stowed position according to an exemplary embodiment;

FIG. 5B is a rear perspective view of a wheeled container showing perforated in a deployed configuration according to an exemplary embodiment;

FIG. 5C is a rear view of a portion of a wheeled container showing perforated stands in a deployed position according to an alternative embodiment;

FIG. 5D is a side view of the wheeled container of FIG. 5C;

FIG. 5E is an exterior view of the wheeled container in an unfolded state showing a rear face according to an alternative embodiment;

FIG. 5F is a perspective view of the rear face shown in FIG. 5E with supports deployed;

FIG. 6A is a side view of a caster assembly according to an exemplary embodiment;

FIG. 6B is a front view of a caster assembly according to an exemplary embodiment;

FIG. 6C is a perspective view of a caster assembly according to an exemplary embodiment;

FIG. 6D is a perspective view of a caster assembly according to an exemplary embodiment;

FIG. 6E is a perspective view of a recessed skate housing with a caster in a first, retracted position;

FIG. 6F is a perspective view of a recessed skate housing with a caster in a second, deployed position;

FIG. 6G is a top view of a recessed skate housing according to an exemplary embodiment;

FIG. 6H is a front view of the recessed skate housing of FIG. 6G;

FIG. 6I is a side view of the recessed skate housing of FIG. 6G;

FIG. 6J is a perspective view of the recessed skate housing of FIG. 6G;

FIG. 7A is a perspective view of a handle assembly in an installed and closed configuration according to an exemplary embodiment;

FIG. 7B is a perspective view of a handle assembly in an installed and open configuration according to an exemplary embodiment; and

FIG. 7C is a perspective view of a handle assembly removed from a wheeled container according to an exemplary embodiment.

### DETAILED DESCRIPTION

Various embodiments of the present invention will now be described more fully with reference to the accompanying drawings. The invention may, however, be embodied in many different forms and should not be construed as limited to the embodiments set forth herein.

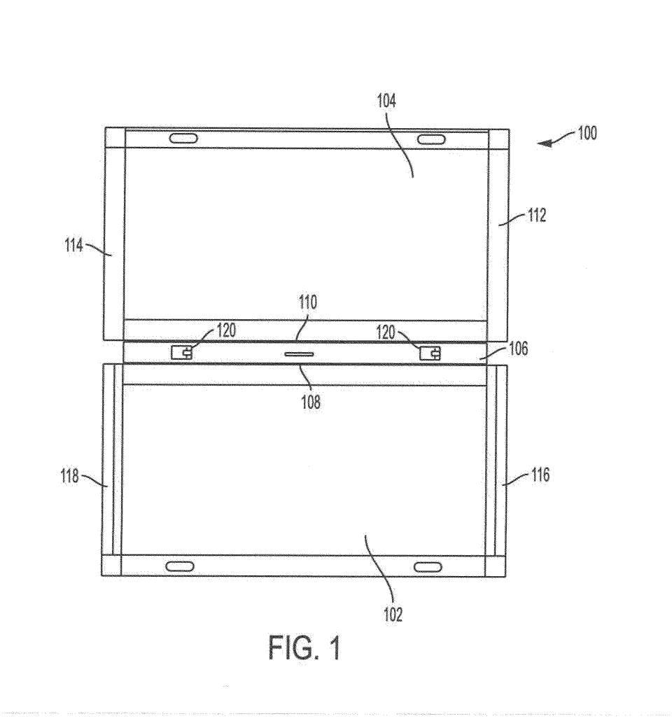

FIG. 1 is a top plan view of a wheeled container 100. The wheeled container 100 includes a front face 102, a rear face 104, and a bottom surface 106. In a typical embodiment the front face 102, the rear face 104, and the bottom surface 106 are constructed of a material such as, for example, cardboard, paper, plastic, wood, various metals, or any other appropriate material as dictated by design requirements. In various embodiments, the bottom surface 106 may be reinforced with, for example, wood, metal, plastic, or any other appropriate material. A plurality of recessed skate housings 120 are formed in the bottom surface. The front face 102 and the rear face 104 are connected to the bottom surface 106 along oppositely-disposed parallel edges 108, 110 of the bottom surface 106. In a typical embodiment, the front face 102, the rear face 104, and the bottom surface are integrally formed of a single piece of material. In such an embodiment, the oppositely-disposed parallel edges 108, 110 define fold lines, which fold lines allow the front face 102 and the rear face 104 to fold upwardly relative to the bottom surface 106 to a position generally perpendicular with the bottom surface 106. Side flaps 112, 114 extend laterally from the rear face 104. The side flaps 112, 114 fold inwardly towards the front face 102. Similarly side flaps 116, 118 extend laterally from the front face 102. The side flaps 116, 118 fold inwardly towards the rear face 104 and are overlapped by the side flaps 112, 114, respectively. Thus, an internal space is defined by the front face 102, the rear face 104, the bottom surface 106, and the side flaps 112, 114, 116, 118. The internal space, in a typical embodiment, receives an article for transport. In a typical embodiment, the article may be fragile such as, for example, structural glass such as. The front face 102, the rear face 104, and the bottom surface 106 have been shown by way of example in FIG. 1 as being integrally formed; however in other embodiments, the front face 102, the rear face 104, and the bottom surface 106 are separately formed and joined together. Similarly, in various embodiments, one or more of sides 112, 114, 116, 118 may be excluded.

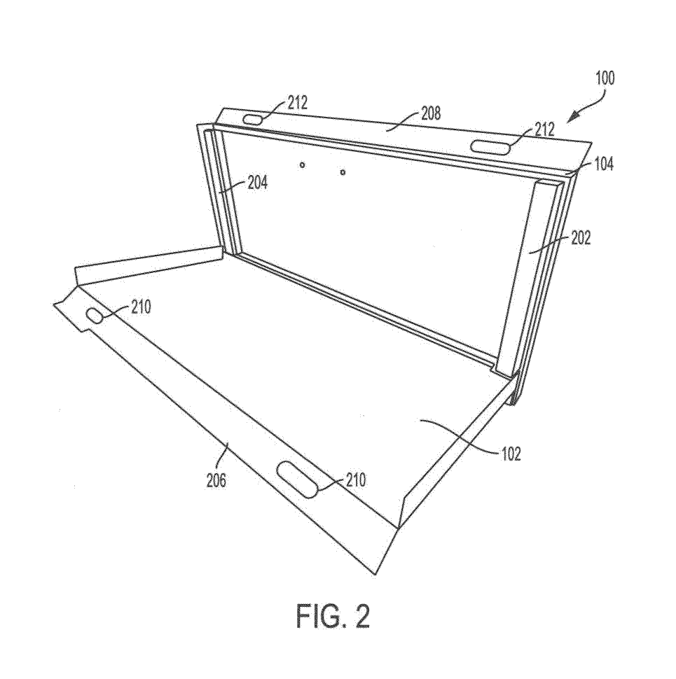

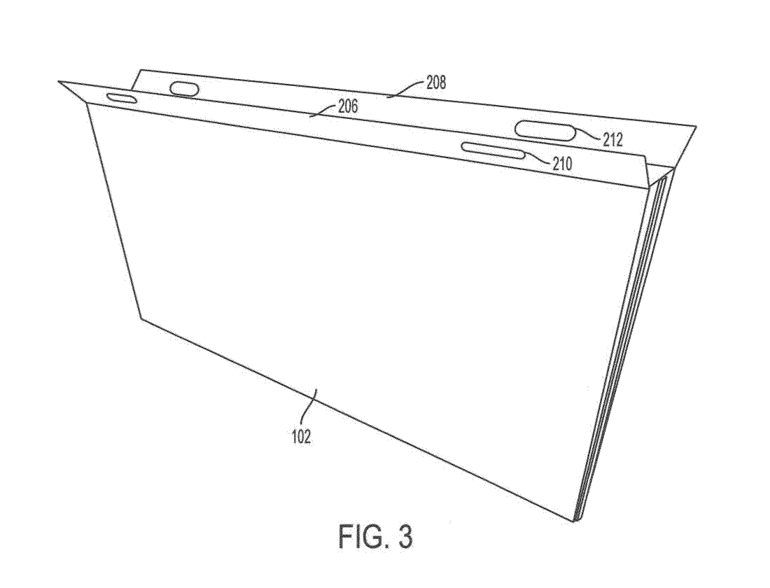

FIG. 2 is a perspective view of the wheeled container 100 in an open configuration. FIG. 3 is a perspective view of the wheeled container 100 in a closed configuration. Referring to FIG. 2, the front face 102 is opened downwardly, away from the rear face 104 thereby revealing the internal space. Vertical supports 202, 204 are disposed within the internal space. In a typical embodiment, the vertical supports 202, 204 may increase rigidity of the front face 102 and the rear face 104. In addition, the vertical supports 202, 204 may secure an article for transport disposed within the internal space. A handle flap 206 extends from the front face 102. A second handle flap 208 extends from the rear face 104. A first plurality of handle openings 210 are formed in the handle flap 206 and a second plurality of handle openings 212 are formed in the second handle flap 208. As illustrated in FIG. 3, when the front face is in the closed position, the first plurality of handle openings 210 and the second plurality of handle openings 212 align in registry with each other and facilitate transport of the wheeled container 100. Although the wheeled container 100 is shown in FIGS. 2 and 3 as having two sets of first handle openings 210 and second handle openings 212, in various other embodiments, the wheeled container may have more or fewer first handle openings 210 and second handle openings 212. Furthermore, the first handle openings 210 and the second handle openings 212 are depicted in FIGS. 2-3 as being disposed along a top of the wheeled container 100; however, in other embodiments, the first handle openings 210 and the second handle openings 212 could be disposed, for example, along the sides of the wheeled container 100.

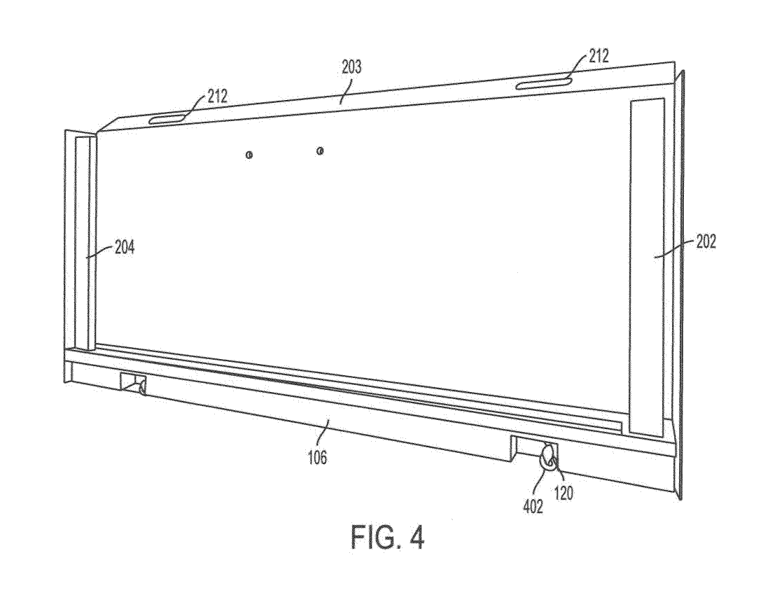

FIG. 4 is a perspective view of the wheeled container 100 with a front face 102 removed. The recessed skate housings 120 are formed in an underside of the bottom surface 106. A caster 402 is disposed in each recessed skate housing 120. During transport, the caster 402 contacts the ground and supports the weight of the wheeled container so as to assist transport of the wheeled container 100. As will be discussed in more detail below, in some embodiments, the caster 402 may be retractable into the recessed skate housing 120. When retracted, the bottom surface 106 contacts the ground and stabilizes the wheeled container 100.

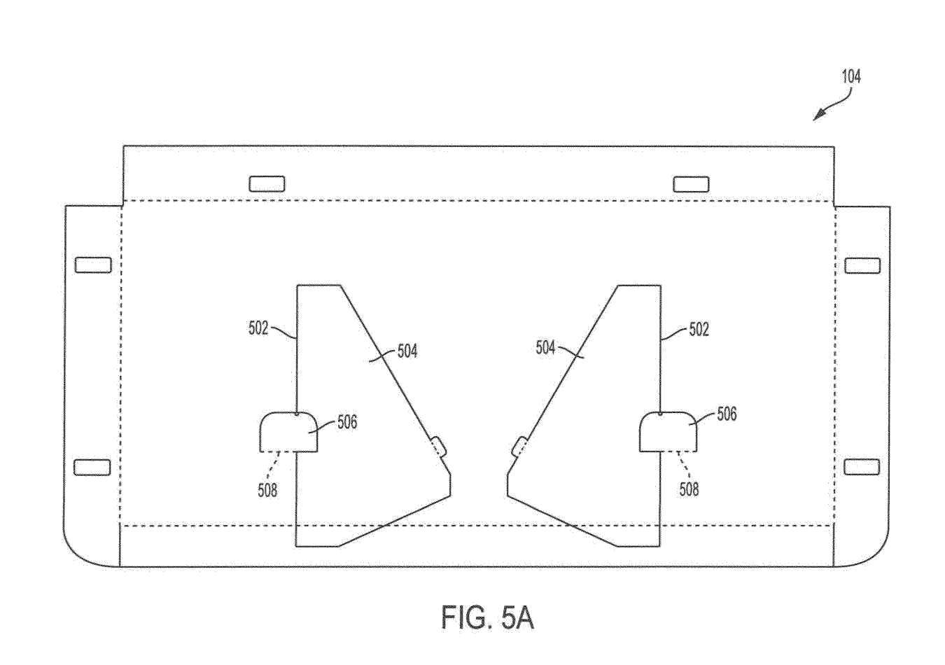

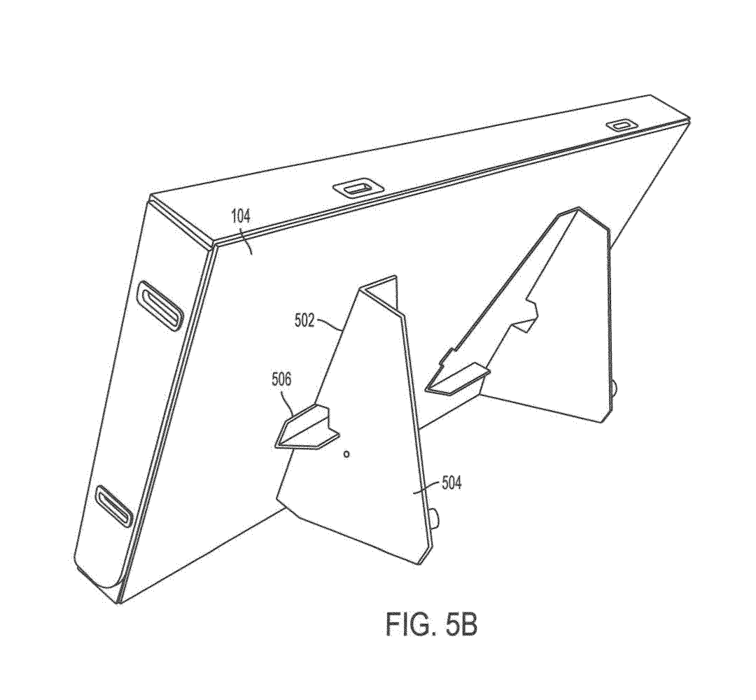

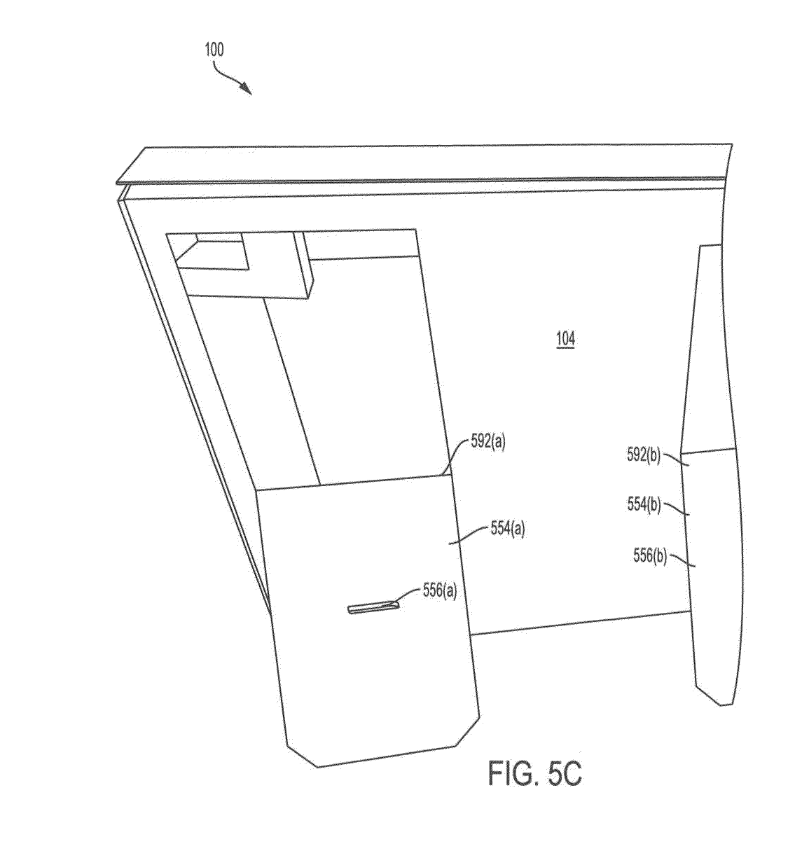

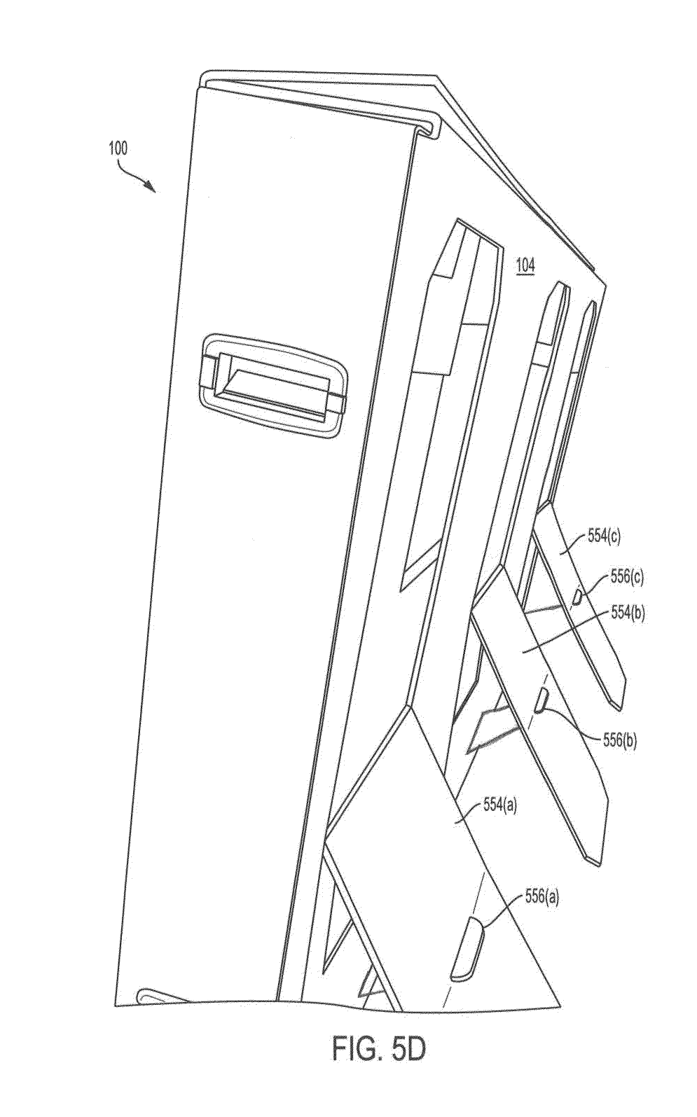

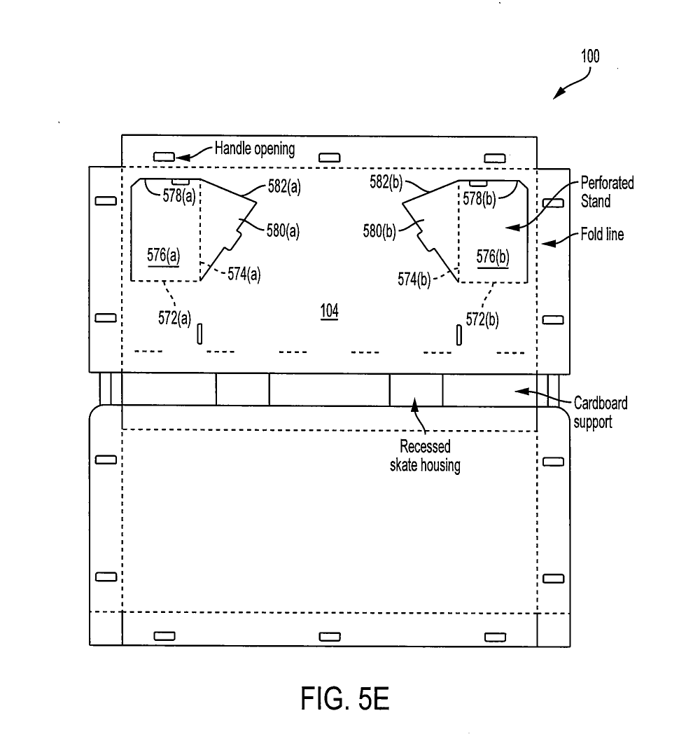

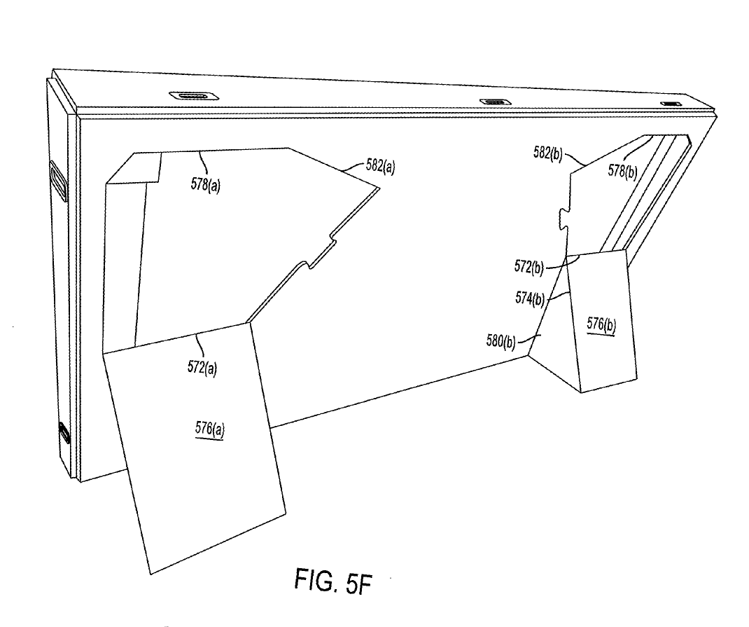

FIG. 5A is a plan view of the rear face 104 showing perforations formed therein. FIG. 5B is a perspective view of the rear face 104 showing stands in a deployed configuration. In some embodiments, the support flaps 504 may be defined by, for example, lines to be cut, partially cut lines, or the support flaps 504 may be perforated such that no tool is required to separate the support flaps 504 from the rear face 104. A pair of generally parallel fold lines 502 are formed in the rear face 104. A support flap 504 extends inwardly from the score line 502. A brace flap 506 is formed generally perpendicular to the score line 502. As shown in FIG. 5B, the support flap 504 rotates outwardly about the score line 502 until the support flap 504 is generally perpendicular to the rear face 104. The brace flap 506 rotates downwardly about a second score line 508. The brace flap 506 is positioned generally perpendicular to the support flap 504 to secure the support flap 504 in the outward position. In some embodiments, the brace flap 506 may include a notch to secure the brace flap in position relative to the support flap 504. As shown in FIG. 5B, when the support flap 504 is deployed outwardly, the wheeled container 100 may be supported by the support flaps 504. In some embodiments, the wheeled container 100 rests at an acute angle relative to the ground. The wheeled container 100 is shown and described herein as having two support flaps 504; however, in other embodiments, wheeled containers utilizing principles of the invention may have any number of support flaps arranged in a variety of configurations. In some embodiments, the support flaps 504 may be configured to support the wheeled container 100 with the casters 402 in a deployed position, a retracted position, or both depending on design characteristics of the wheeled container 100 and the article 100.

FIG. 5C is an exterior view of the rear face 104 according to an alternative embodiment. FIG. 5D is a side view of the rear face 104 shown in FIG. 5C. Three fold lines 552(a)-(c) are formed on the rear face 104. Support flaps 554(a)-(c) extend upwardly from the fold lines 552(a)-(c). Brace flaps 556(a)-(c) are formed below the fold lines 552(a)-(c). The brace flaps 556(a)-(c) rotate outwardly from the rear face 104 and hold the support flaps 554(a)-(c) in a deployed position. When the support flaps 554(a)-(c) are deployed outwardly, the wheeled container 100 may be supported by the support flaps 554(a)-(c) so that the wheeled container 100 rests at an acute angle relative to the ground.

FIG. 5E is an exterior view of the rear face 104 according to an alternative embodiment. FIG. 5F is a perspective view of the rear face 104 shown in FIG. 5E. Two support-flap fold lines 572(a)-(b) are formed in the rear face 104. The two support-flap fold lines 572 (a)-(b) are oriented in a direction parallel to a long axis of the rear face 104. Two brace-flap fold lines 574(a)-(b) are formed in the rear face 104 in a direction generally perpendicular to the support-flap fold lines 572(a)-(b). Support flaps 576(a)-(b) are defined by the support-flap fold lines 572(a)-(b), the brace-flap fold lines 574(a)-(b), and perforated boundaries 578(a)-(b). Brace flaps 580(a)-(b) are defined by the brace-flap fold lines 574(a)-(b) and the perforated boundaries 582(a)-(b). The support flaps 576(a)-(b) and the brace flaps 580(a)-(b) fold downwardly about the support-flap fold lines 572 (a)-(b). The brace flaps 580(a)-(b) fold inwardly about the brace-flap fold lines 574(a)-(b) to brace the support flaps 576(a)-(b) against the rear face 104. When the support flaps 576(a)-(b) are deployed, the wheeled container 100 may be supported by the support flaps 576(a)-(b) and the brace flaps 580 (a)-(b) so that the wheeled container 100 rests at an acute angle relative to the ground. In some embodiments, the brace flaps 580(a)-(b) engage slots 583(a)-(b) formed in the rear face 104 thereby securing the brace flaps 580(a)-(b) in place.

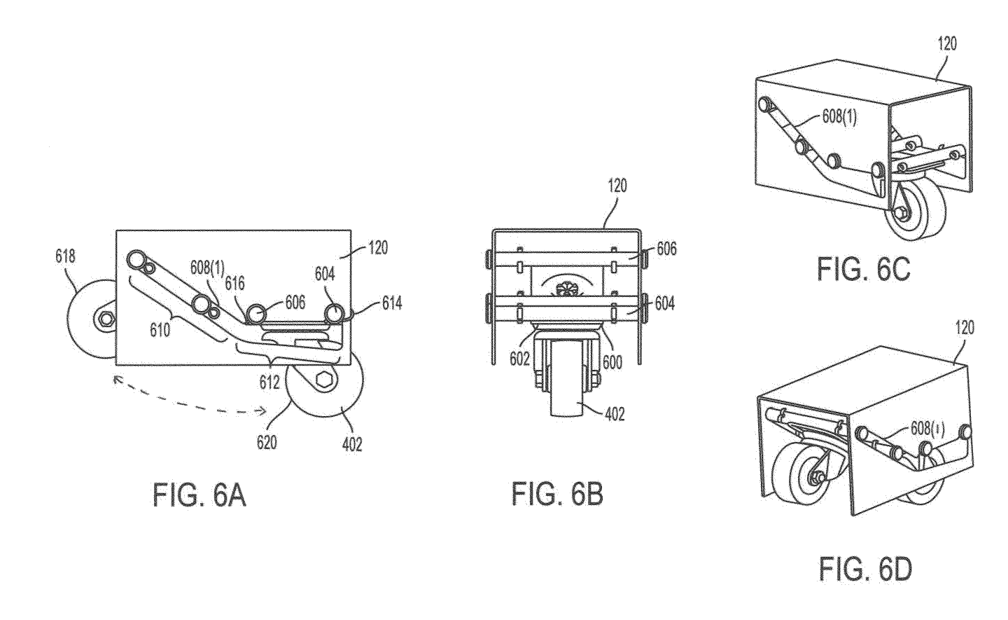

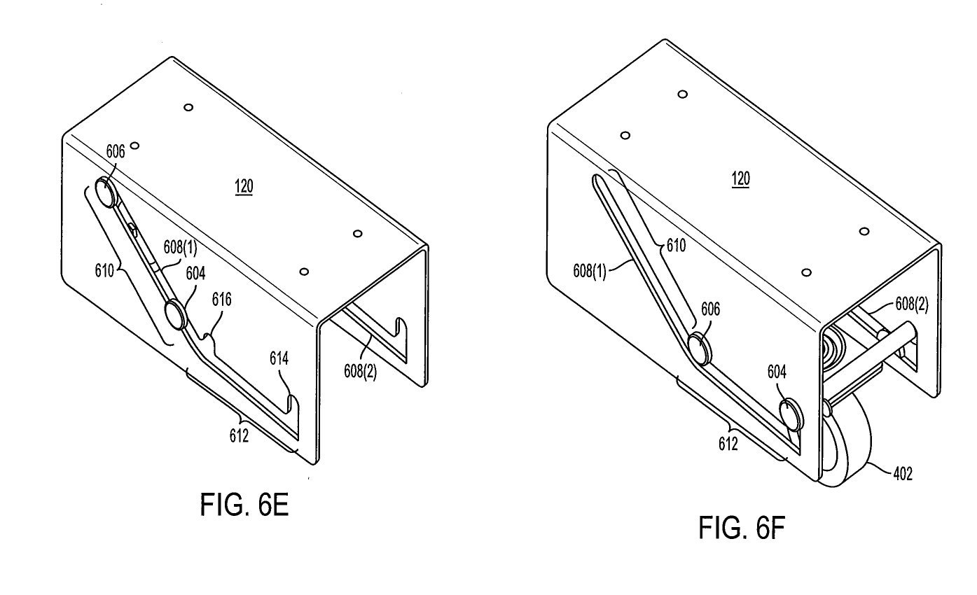

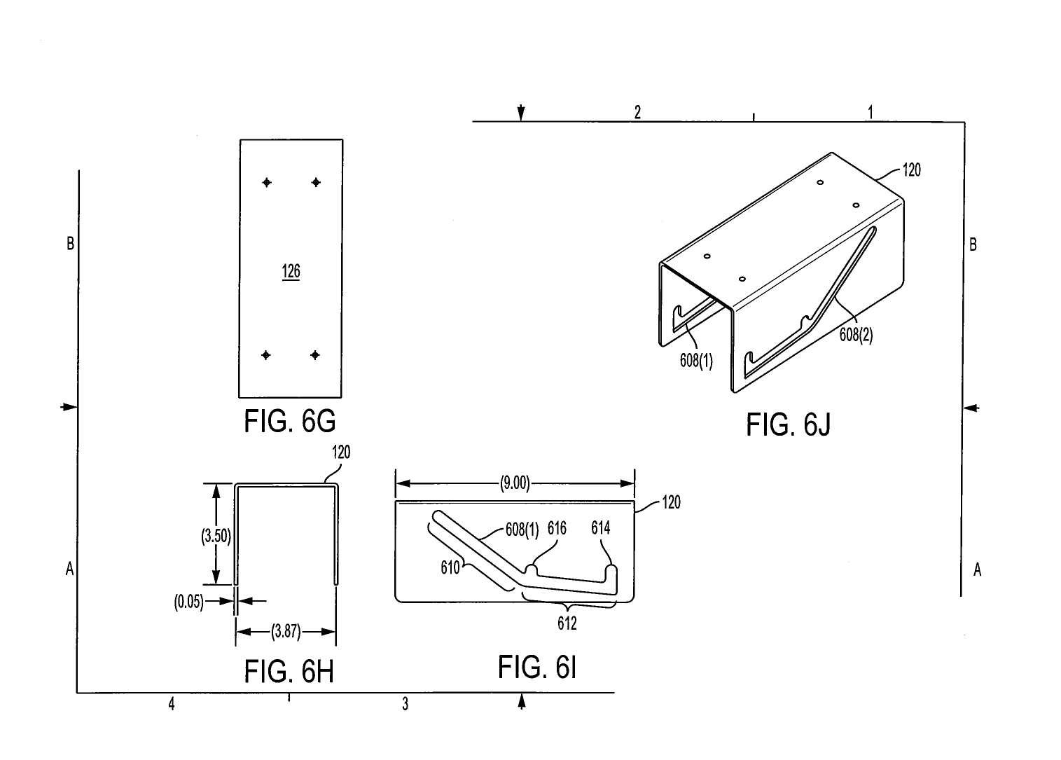

FIG. 6A is a side view of a caster assembly 600 installed in the recessed skate housing 120. FIG. 6B is a front view of the caster assembly 600 installed in the recessed skate housing 120. FIG. 6C is a perspective view of the caster assembly 600 installed in the recessed skate housing 120. FIG. 6D is a perspective view of the caster assembly 600 installed in the recessed skate housing 120. The caster assembly 600 includes the caster 402, a swivel 602, a first pin 604, and a second pin 606. Referring to FIGS. 6A-6D collectively, the caster 402 is rotatably coupled to the swivel 602. The first pin 604 and the second pin 606 are coupled to an upper side of the swivel 602 in a generally parallel configuration. In some embodiments, the casters 402 may be fixed, may swivel, or may be able to be switched between a fixed state and a swivel state. Respective ends of the first pin 604 and the second pin 606 are received in a slots 608(1) and 608(2) that are formed in opposed generally parallel sides of the recessed skate housing 120. The slot 608(1) and the slot 608(2) align in registry so as to receive opposite ends of the first pin 604 and the second pin 606. Detailed views of the recessed skate housing are shown in FIGS. 6G-6J. In various embodiments, the recessed skate housing 120 may be secured to the bottom surface 106 via screws, snaps, glue. Additionally, in various embodiments, the recessed skate housing 120 may be formed of, for example, metal or plastic. Alternatively, in other embodiments, the recessed skate housing 120 may be integrally formed with the bottom surface 120.

Still referring to FIGS. 6A-6D, the slot 608(1) and the slot 608(2) include a first portion 612 that may be oriented generally parallel to the ground and a second portion 610 that may be upwardly angled relative to the first portion 612. A first notch 614 and a second notch 616 are formed in a upper boundary of the first portion 612. In a typical embodiment, a spacing between the first notch 614 and the second notch 616 is approximately equal to a spacing between the first pin 604 and the second pin 606. As illustrated in FIG. 6A, the caster assembly 600 slides between the first portion 612 and the second portion 610 to allow the caster assembly 600 to translate between a first, retracted, position 618 and a second, deployed, position 620. When in the first position 618, the caster 402 is fully concealed by the recessed skate housing 120 and does not rest upon the ground. When the caster assembly is in the second position 620, the caster 402 contacts the ground and facilitates transport of the wheeled container 100. Further, when in the second, deployed position 620, the first pin 604 is received into the first notch 614 and the second pin 606 is received into the second notch 616 to secure the caster assembly 600 in the second, deployed position 620 and prevent accidental movement of the caster assembly 600 to the first retracted position 618 during transport. In various embodiments, a plurality of notches may be formed in the second portion 610 to prevent accidental movement of the caster assembly 600 from the first, retracted position 618 to the second, deployed position 620. By way of illustration, FIGS. 6A-6D show a first caster 402 in the first position 618 and a second caster in the second position 620; however; as shown in FIGS. 6E-6F, a single caster 402 is disposed in the recessed skate housing 120. In some embodiments, the recessed skate housing 120 may include one or a plurality of casters 402. For example, in various embodiments, the wheeled container 100 may include two sets of casters 402 arranged in a side-by-side configuration.

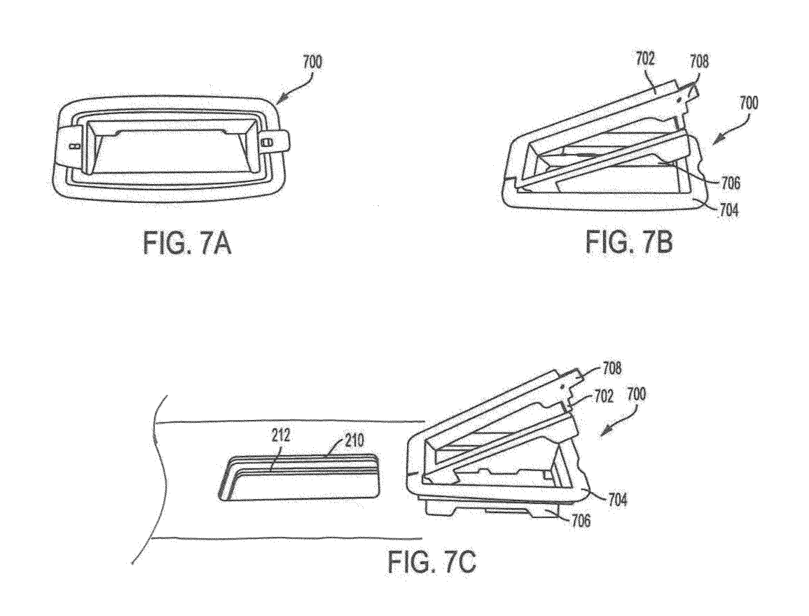

FIG. 7A is a perspective view of a handle assembly 700 in an installed and closed configuration. FIG. 7B is a perspective view of the handle assembly 700 in an installed and open configuration. FIG. 7C is a perspective view of the handle assembly 700 removed from the wheeled container 100. Referring to FIGS. 7A-7C collectively, in a typical embodiment, the handle assembly 700 is received in the handle openings 210 and the handle openings 212 and thereby secures the handle openings 210 in registry with the handle openings 212. The handle assembly 700 comprises a latch 702 that is hingedly coupled to frame 704 and rotatable between an open position (shown in FIG. 7B) and a closed position (shown in FIG. 7A). A plurality of protrusions 706 extend outwardly from the an underside of the frame 704. During installation, the latch 702 may be initially in the open position. The frame 704 may be inserted into the handle openings 210 which are aligned in registry with the handle openings 212. When the frame 704 is positioned as illustrated in FIG. 7B, the latch 702 is moved to the closed position as illustrated in FIG. 7A. Rotation of the latch 702 causes the protrusions 706 to move outwardly from the underside of the frame 704. The protrusions 706 bite into the material surrounding the handle openings 212 and secure the frame 704 in position. A catch 708 is disposed on the latch 702 to prevent accidental release of the latch 702 during transport. In various embodiments, the protrusions 706 bite into the material surrounding the handle openings 212 when the latch 702 is moved to the closed position. In alternative embodiments, the protrusions 706 may close over the material surrounding the handle openings 210 thereby securing the handle openings 210 to the handle openings 212.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications, and substitutions without departing from the spirit and scope of the invention.

What is claimed is:

1. A wheeled container comprising:
a front face;
a rear face disposed opposite the front face;
a bottom surface coupled to the rear face and the front face;
a recessed skate housing disposed in the bottom surface, the recessed skate housing comprising a slot that receives a caster assembly; and
wherein the caster assembly is moveable within the slot between a first retracted position and a second deployed position.

2. The wheeled container of claim 1, comprising a support flap formed in the rear face.

3. The wheeled container of claim 2, wherein the support flap is rotatable from a stowed position to a deployed position, the deployed position being generally perpendicular to the rear face.

4. The wheeled container of claim 2, wherein the support flap bears a weight of the wheeled container.

5. The wheeled container of claim 1, wherein the slot comprises a first portion and a second portion, the first portion being upwardly angled relative to the second portion.

6. The wheeled container of claim 5, wherein the first portion corresponds to the first retracted position and the second portion corresponds to the second deployed position.

7. The wheeled container of claim 5, comprising a first notch and a second notch formed in an upper boundary of the slot.

8. The wheeled container of claim 7, wherein the first notch and the second notch secure the caster assembly in the second deployed position.

9. The wheeled container of claim 1, wherein the front face opens relative to the rear face.

10. The wheeled container of claim 1, wherein the front face, the rear face, and the bottom surface define a interior space that secures an article of structural glass.

11. A method of transporting structural glass, the method comprising:
moving a wheeled container that contains an article of structural glass, the wheeled container comprising a front face, a rear face, and a bottom surface, a plurality of recessed skate housings being formed in the bottom surface;
retracting a caster coupled to the recessed skate housing such that the bottom surface is in contact with the ground;
deploying a support flap from the rear face to a position generally perpendicular to the rear face; and
supporting the wheeled container with the support flap.

12. The method of claim 11, wherein the recessed skate housing comprises a slot having a first portion and a second portion, the first portion being upwardly angled relative to the second portion.

13. The method of claim 12, wherein the first portion corresponds to a first retracted position and the second portion corresponds to a second deployed position.

14. The method of claim 12, wherein the slot comprises a first notch and a second notch formed in an upper boundary of the slot.

15. The method of claim 14, wherein the first notch and the second notch secure the caster assembly in a second deployed position.

16. The method of claim 11, wherein the front face opens relative to the rear face.

17. The method of claim 11, wherein the front face, the rear face, and the bottom surface define a interior space that secures an article of structural glass.
